(19) United States
(12) Patent Application Publication
(10) Pub. No.: US 2023/0251387 A1
(43) Pub. Date: Aug. 10, 2023

(54) PRECISION APPROACH AND LANDING SYSTEM FOR AIRCRAFT

(71) Applicants: Airbus Defence and Space GmbH, Taufkirchen (DE); NavPos Systems GmbH, Uhldingen-MUhlhofen (DE)

(72) Inventors: Helmut Blomenhofer, Uhldingen-MUhlhofen (DE); Matthias Göttken, Taufkirchen (DE); Christoph Diesch, Taufkirchen (DE); Eduarda M.T. Blomenhofer, Uhldingen-MUhlhofen (DE)

(21) Appl. No.: 18/160,405

(22) Filed: Jan. 27, 2023

Related U.S. Application Data
(63) Continuation of application No. PCT/EP2021/070944, filed on Jul. 27, 2021.

(30) Foreign Application Priority Data
Jul. 28, 2020 (DE) 10 2020 119 803.5

(51) Int. Cl. G01S 19/15; G01S 19/07; G01S 19/41

(52) U.S. Cl. CPC G01S 19/15; G01S 19/071; G01S 19/41; B64U 10/00

(57) ABSTRACT

An aircraft with a mission computer, a GNSS receiver with a first air interface and a first receiver and a data transmission unit with a second air interface and a second receiver. The data transmission unit can receive data via an encrypted, bidirectional communication path. The mission computer determines a position value for the aircraft based on satellite signals from the GNSS receiver to which a correction term has been applied, which is transmitted to the aircraft by the data transmission unit to determine corrected satellite signals. The corrected satellite signals are the basis for determining corrected position value. The mission computer uses a GNSS receiver and data transmission unit as part of the aircraft. A ground arrangement is provided with an associated ground station and optionally a test unit for checking correct determination of the corrected position value.

### TECHNICAL FIELD

An aircraft and a ground arrangement of a ground-based approach and landing system are described. The aircraft is designed to use integrated components of the aircraft to determine a corrected position value of the aircraft based on a correction term provided by the ground arrangement.

### BACKGROUND

Satellite-based positioning systems are used to determine the position of a corresponding receiver on the Earth's surface or in the atmosphere. However, the accuracy of the position determined in this way may vary. For critical applications, it may be necessary to correct the position determined on the basis of satellite signals. For this correction, the known position of a reference object as well as the satellite signals observed or detected at this reference object (in particular the pseudo range measurements recorded at this reference object) are typically used to determine a correction term, which is to be applied to pseudo range measurements in order to determine a corrected or correct position based on the corrected pseudo range measurements.

Such systems are typically used to determine a highly accurate position of an aircraft when approaching a specified location. This can be, for example, the approach to a runway or to a drop-off point of personnel or a drop point of material.

### SUMMARY

It can be considered as an objective to simplify the functional and structural design of an aircraft, which is designed to interact with a ground-based support system or a precision approach and landing system.

This objective is achieved by the subject disclosed herein. Further embodiments result from the following description.

According to a first aspect, an aircraft is indicated, comprising a mission computer, a Global Navigation Satellite System receiver, a GNSS receiver, with a first air interface and a first receiver, and a data transmission unit having a second air interface and a second receiver, wherein the data transmission unit is designed to receive data via an encrypted, bidirectional communication path. The first receiver in the GNSS receiver is designed to receive satellite signals from satellites, which allow the determination of a signal propagation time between a respective satellite and the GNSS receiver, wherein the satellite signals can be used for determining a position value of the aircraft and wherein the GNSS receiver is designed to transmit the determined signal propagation time to the respective satellite to the mission computer. The data transmission unit is designed to receive a correction term for applying to the satellite signals received from the GNSS receiver from a remote station and to transmit this to the mission computer. The mission computer implements a function module which is designed to determine corrected satellite signals based on the satellite signals transmitted by the GNSS receiver to the mission computer and the correction term and to use the corrected satellite signals to determine a position value of the aircraft. The GNSS receiver is designed to be used for navigation in the aircraft and the data transmission unit is designed to transmit data between the aircraft and the remote station, and the function module in the mission computer is structurally separated from the GNSS receiver and the data transmission unit.

The mission computer is a computing unit that controls some or all functions of the aircraft. The mission computer may be, for example, a generic computer that executes commands and arithmetic operations in the form of machine-readable instructions. Here, the mission computer can make use of requirements or inputs from an operator or a pilot. The mission computer can be a single computer or a group of computers.

This design of the aircraft provides for the multiple use of certain components, namely the GNSS receiver and the data transmission unit. The GNSS receiver is a receiver designed for receiving navigation signals (i.e. satellite signals), which is also used in the aircraft for determining the positions of other function blocks. The data transmission unit is, for example, a Link 16 interface, i.e. a data interface, which is predominantly used in the military environment and meets corresponding requirements for military use. If reference is made in this description to a Link 16 interface, it should always be understood that the corresponding statement applies generally to the data transmission unit and not only to the Link 16 interface. A Link 16 interface is typically implemented in military aircraft.

The GNSS receiver is not just a mere antenna, but also contains an air interface and a receiver. The same applies to the data transmission unit, which has its own air interface and its own receiver.

The GNSS receiver has an air interface that receives a wireless satellite signal. This satellite signal contains navigation data transmitted by a navigation satellite. The satellite signal is received by the air interface, such as a GPS antenna, and forwarded to the receiver. The receiver processes the navigation data. The navigation data contain several values, such as satellite clock parameters and the age of a message, exact position data of the transmitting satellite (so-called ephemeris data), information about the ionospheric status, the coordinated universal time (UTC), possibly a military message, flags, rough position data of all satellites in the constellation and their condition (so-called almanac). The receiver in the GNSS receiver takes some measurements on the satellite signals received from the air interface, for example so-called pseudo range measurements, possibly determining a receiver clock error, and carrier phase measurements. The receiver of the GNSS receiver uses the satellite signals from at least four navigation satellites and calculates a value for the position, speed and time of the aircraft from the navigation data and the measurement data.

For example, a GNSS receiver as described herein applies the following working principle: a signal of a navigation satellite is tracked in a channel of the receiver; for military GPS receivers, for example, 24 channels are used, which track up to twelve satellites on two frequencies each (civilian GPS receivers use twelve channels); in principle, GNSS receivers with more than the number of channels specified here are also conceivable. The information contained in the satellite signal is read out in the receiver. The satellite signal contains, among other things, the position of the satellite and its time. At the same time, a propagation time measurement of the satellite signal takes place in the receiver. The receiver clock is usually not synchronized with the time of the navigation satellite, which is why the signal propagation time measurement multiplied by the speed of light (as the propagation speed of the satellite signal) is referred to as a pseudo distance measurement. These measured pseudo distances are improved with corrections from a ground station in the case of differential GPS, LAAS (Local Area Augmentation System) and GBAS (Ground Based Augmentation System). The receiver clock error is determined together with position and speed. Carrier phase measurements and Doppler measurements are also carried out. The pseudo distances are corrected with the correction term and monitored for integrity.

In the case of GBAS, a local ground station at a certain point on the earth's surface, for example at an airport, continuously observes the navigation satellites and compares the position values determined with the help of the navigation signals with the known position values of the ground station. This allows correction values for the satellite signals to be determined. The correction values are transmitted to aircraft via a data connection and processed there.

The principle described here stipulates that no central multi-mode receiver is used to receive navigation signals and data communication signals. Instead, both the GNSS receiver and the data transmission unit contain their own receiver. The receiver in the GNSS receiver and also in the data transmission unit is preferably designed so that it can receive, decrypt and process encrypted signals (navigation signals or data communication signals). For the position determination, an encrypted data connection already installed in the aircraft, for example Link 16, is used, which has its own air interface and its own receiver. The GNSS receiver preferably contains a receiver with a connected anti-jamming antenna. Both the GNSS receiver and the data transmission unit provide their output data to the mission computer, which, for example, implements a functional unit as a software module that receives and processes the data from the GNSS receiver and the data transmission unit. This represents a decentralized architecture and uses the three modules mission computer, GNSS receiver, and data transmission unit, which are replaceable as standalone modules.

The aircraft described herein is designed to that a function module is implemented on the mission computer, and this function module uses the existing GNSS receiver and the aircraft's data transmission unit to determine corrected satellite signals for determining the position value of the aircraft. In order to determine the corrected satellite signals for determining the position of the aircraft, the mission computer works together with the GNSS receiver and the data transmission unit. The GNSS receiver receives satellite signals and, based on these, determines a signal propagation time between a respective satellite and the receiver or aircraft. It may happen that the signal propagation time determined in this way is not sufficiently accurate and requires correction. This correction is made by applying a correction value of a correction term to the determined signal propagation time.

In particular, the correction term contains several correction values, wherein each correction term is applied to the measured signal propagation time between the GNSS receiver and a specific satellite. The correction term contains individual correction values, each of which is assigned to a satellite and of which a respective correction value is to be applied to a satellite signal. In other words, the correction term is used to correct the individual signal propagation times from a specific satellite of a plurality of satellites. In addition, the correction term can contain a quality factor for each correction value, which indicates the quality of the individual correction value. This is therefore a differential approach whereby the propagation time measurements of the signals from several satellites (for example 4 or more) are used and corrected, wherein the GNSS receiver carries out its own receiver clock offset and other corrections, some of which are due, for example, to the signal transmission and its interference by the atmosphere. The correction term contains corresponding values to correct the individual propagation time measurements.

In addition to the information purely for the correction of the signal propagation time, information about the quality of the individual correction values can also be transmitted. For this purpose, several GNSS receivers, for example two to four, can be arranged in a ground station and their measurements of the signal propagation time can be compared with each other. If anomalies occur, they can be detected and isolated with the aim of achieving the highest level of integrity and limiting the integrity risk. In addition, reference station data and approach data can also be transmitted from the ground station to the aircraft.

The correction term is transmitted to the aircraft via a data connection, in this case via the Link 16 interface. The mission computer applies the correction values of the correction term to the satellite signals of the associated satellites, so that the individual signal propagation times are corrected and serve as the basis for determining a corrected position value.

The signal propagation times between a satellite and the GNSS receiver used here can serve in particular as a basis for calculating a distance between a satellite and the GNSS receiver. In this respect, determining the signal propagation time is equivalent to determining the distance between a satellite and the GNSS receiver. The GNSS receiver may therefore be designed to determine the signal propagation time and/or the distance to a satellite.

The GNSS receiver and the Link 16 interface are structurally separated from the mission computer, and thus from the function module implemented on it. Thus, the components used in the aircraft for determining the corrected signal propagation times are modular and individually replaceable, which, for example, allows the function of a precision approach and landing system (PALS) to be implemented on an aircraft without hardware modifications. In particular, there is no tight structural coupling between the function module, the GNSS receiver and the Link 16 interface in a single structural module, which can only be replaced as a whole.

The aircraft as described herein thus dispenses with a separate GNSS receiver and a separate data connection for determining the corrected position of the aircraft and instead uses the GNSS receiver and the Link 16 interface, which are already present in the aircraft. This avoids the use of a separate assembly for determining the corrected signal propagation times, which reduces the number of assemblies installed in the aircraft and also the weight of the aircraft. The way the mission computer, the GNSS receiver and the Link 16 interface interact with each other makes it possible to modify or even replace each of these components individually and independently of the other components.

According to one embodiment, the function module is implemented as a software module and is designed to be implemented on the mission computer.

The function module which receives the satellite signal propagation times from the GNSS receiver and the correction term from the Link 16 interface and thus first determines corrected signal propagation times and a corrected position for the aircraft, is implemented as a module on the mission computer and not on a separate and dedicated computing unit. If the function module has to be adjusted or changed, this process can be carried out by a simple change of the function module, without a change or replacement of hardware being absolutely necessary.

According to a further embodiment, the GNSS receiver is designed to receive and process satellite signals from a satellite of one of the following satellite navigation systems: GPS, Galileo, Glonass, Beidou.

Ultimately, it is irrelevant for the mission computer and the function module implemented on it from which satellite constellation and in which format the GNSS receiver receives the satellite signals, as long as the interface and the transmission format between the GNSS receiver and the function module are specified on the mission computer and adhered to. In any event, the aircraft described herein may not only operate with a particular satellite navigation system but may also access and use satellite signals from any or different satellite navigation systems. At most, the GNSS receiver must be modified or replaced, and the remaining components can be retained.

According to a further embodiment, the first receiver in the GNSS receiver is designed to determine the signal propagation time between a respective satellite and the GNSS receiver by a pseudo range measurement and optionally a carrier phase measurement on the satellite signals.

The pseudo range measurement and optionally the carrier phase measurement are also carried out, for example, in the first receiver. These two measurements make it possible to determine the signal propagation time between a satellite and the GNSS receiver. The correction term is applied in particular to these two measurements in order to obtain corrected pseudo ranges/carrier phases, which serve as the basis for determining a corrected position value. The carrier phase measurement is optional. If the carrier phase of a satellite signal is measured, the measured carrier phase is used in particular to smooth the value of the pseudo range measurements.

According to a further embodiment, the first receiver is designed to receive encrypted satellite signals for determining the position of the aircraft and to decrypt the encrypted satellite signals.

The first receiver in the GNSS receiver can, for example, receive and process military satellite signals for the position determination. Encryption also provides some protection against signal manipulation and/or deception, for example against jamming and spoofing.

Precisely because the satellite signals are encrypted, it may be advantageous that the first receiver is decentralized in the GNSS receiver and is not implemented as a central multi-mode receiver for both satellite signals and, if appropriate, data transmission signals. Preferably, the GNSS receiver has its own receiver and also the data transmission unit has its own receiver. Thus, both the GNSS receiver on the one hand and the data transmission unit on the other hand can receive, decrypt and process the corresponding signals.

According to a further embodiment, the function module of the mission computer is designed as a remote station of a ground-based approach and landing system.

The aircraft receives the correction term from a ground-based remote station in order to correct the satellite signals received from its GNSS receiver or their signal propagation times and, based on this, to determine a corrected position or to adjust the previously determined position if appropriate. In order to perform this function, the aircraft accesses data it receives from the ground-based remote station via the Link 16 interface.

According to a further embodiment, the data transmission unit is designed to receive flight path related data for the aircraft.

The data transmission unit is not only used to obtain the correction term from the ground-based remote station but is generally used to transmit data to the aircraft. For example, tactical or mission-related data or an approach path can be transmitted to the aircraft via the data transmission unit. Thus, the correction term for determining the corrected signal propagation times for the position determination of the aircraft is not transmitted via a dedicated link, but via a data connection over which other data are also transmitted to the aircraft. This data connection even uses the existing physical interfaces (antennas) and does not require separate physical interfaces for the transmission of the correction term.

In summary, therefore, the task of determining corrected signal propagation times of satellite signals received by the GNSS receiver in the aircraft is distributed using components already present in the aircraft such as the GNSS receiver and the Link 16 interface and the mission computer and the use of an assembly specially intended for this task with its own hardware is dispensed with.

According to a further embodiment, the data transmission unit is designed to transmit data to the remote station and/or other aircraft, wherein the data transmitted to the remote station are one or more elements from the following group: an approach path selected by the aircraft; the determined signal propagation times corrected by the correction term.

In contrast to a unidirectional data connection, which only transmits a correction term to the aircraft, the data transmission unit, for example in the form of a Link 16 interface, enables bidirectional communication. The ground station can initially transmit approach paths to the aircraft. In the aircraft, an approach path is selected manually by a pilot or autonomously and communicated to the ground station. The aircraft can then transmit the signal propagation times corrected by the correction term and, if appropriate, other data (flight path deviations, protection levels for the integrity monitoring, etc.) to the ground station so that the corrected signal propagation times can be fed to a further check in the ground station, for example by an integrity monitoring method. The ground station or the aircraft may inform other aircraft or the approaching aircraft if the transmitted data do not permit a safe approach.

Especially in connection with unmanned aircraft, the bidirectional data connection is advantageous because the corrected integrity position solution can be transmitted via the return channel to the ground station, where the corrected position can be checked and confirmed if appropriate. It is conceivable that an unmanned aircraft can only use a corrected position value for the approach manoeuvre after the corrected position value has been confirmed by the ground station.

The Link 16 interface is therefore not only intended to receive the correction term from the ground-based remote station but can also be designed as a transceiver unit for bidirectional communication, which can send data to other aircraft and, in addition to the data sent by the ground-based remote station, can also receive data from other aircraft. The aircraft may, for example, make the correction term received from the ground-based remote station available to other aircraft.

According to another embodiment, the aircraft is a manned or unmanned military aircraft.

The functional and structural principles of the aircraft design described herein may be used in any military aircraft, such as helicopters, transport aircraft, combat aircraft or drones, wherein this list is to be understood as exemplary and not limiting.

According to another aspect, a ground arrangement of a ground-based approach and landing system is specified, wherein the ground arrangement comprises a ground station, and the ground station comprises: a computing unit, a global navigation satellite system receiver, a GNSS receiver, with a third air interface and a third receiver, and a data transmission unit with a fourth air interface and a fourth receiver, wherein the data transmission unit is designed to receive data via an encrypted, bidirectional communication path. The third receiver in the GNSS receiver is designed to receive satellite signals from satellites, which allow the determination of a signal propagation time between a respective satellite and the GNSS receiver, wherein the satellite signals can be used for determining a position value of the ground station, wherein the GNSS receiver is designed to transmit the satellite signals to the computing unit. The computing unit is designed to determine a correction term for the satellite signals received from the GNSS receiver based on the satellite signals received from the GNSS receiver and a known actual position value of the ground station, so that the correction term after application to the satellite signals transmitted by the GNSS receiver to the computing unit results in corrected satellite signals corresponding to the actual position value of the ground station. The data transmission unit is designed to transmit the correction term to a remote station. The computing unit is structurally separated from the GNSS receiver and the data transmission unit.

The ground station is thus the counterpart to the aircraft. In the ground station, the correction term is calculated by the GNSS receiver of the ground station first determining a signal propagation time of the satellite signals to the GNSS receiver of the ground station. Based on the determined signal propagation time, a position value is determined. Then, based on the determined position value and the initially obtained signal propagation times, corrected signal propagation times are determined in order to arrive at the actual position value. The difference between the determined signal propagation times and the corrected signal propagation times (target signal propagation times) serves as a basis for determining the correction term. Conversely, this means that the correction term corrects the originally determined signal propagation times so that the corrected signal propagation times result in a correct position value. The actual position value of the ground station or the expected signal propagation times for the actual position can be entered, for example, by an operator of the ground station and are based on known coordinates of a reference object or reference point. For this purpose, the ground station can be set up near the reference object or reference point or even at the reference object or reference point.

The ground station is characterized in that it has a data transmission unit by which the correction term is transmitted to an aircraft, which is designed to receive and process data.

The ground station is preferably located near a point to be approached by the aircraft. When it comes to the ground station supporting the landing approach of an aircraft, the ground station is set up close to the runway. However, the ground station can also be set up near a location to be approached by the aircraft. In general, GNSS receivers which are in close proximity to each other (within a radius of a few kilometers to a few tens of km or even hundreds of km) experience a similar or even the same error magnitude for the satellite signal propagation times. This behavior is used in the present case by setting up the ground station near the point to be approached by the aircraft, because then the aircraft experiences the same error magnitude for its signal propagation times as the ground station when the aircraft approaches the ground station.

The ground station thus supports an aircraft in determining its actual position (or the signal propagation times corresponding to the actual position) with high accuracy, which would not be achievable with data from a navigation satellite system alone. The data from the navigation satellite system and the correction term from the ground station provide precise information for approaching a location defined by coordinates, even in poor visibility or with zero visibility. In particular during landing, position values for the aircraft must be specified with sufficiently high integrity to allow an aircraft to land even in bad weather conditions with limited visibility.

The ground station is mobile or deployable and can be set up quickly, for example within two hours to commissioning.

In a preferred example, the ground arrangement comprises at least two and at most four GNSS receivers (each with an air interface and a receiver), which receive satellite signals and measure the pseudo ranges to the respective satellites. The position coordinates of the GNSS receivers, in particular the air interfaces/antennas, are measured very accurately (to a few centimeters, no more than 10 centimeters) relative to a runway or other reference point.

According to one embodiment, the ground arrangement further comprises a test unit, wherein the test unit comprises a second computing unit, a second GNSS receiver, and a second data transmission unit which is designed to receive data via an encrypted, bidirectional communication path. The test unit is located at a distance from the ground station. The second GNSS receiver is designed to receive satellite signals from satellites which allow the determination of a signal propagation time between a respective satellite and the second GNSS receiver, wherein the satellite signals can be used for determining a position value of the test unit and wherein the second GNSS receiver is designed to transmit the satellite signals to the second computing unit. The ground station is designed to transfer the correction term by the data transmission unit to the second data transmission unit. The second computing unit is designed to determine corrected satellite signals based on the satellite signals transmitted by the second GNSS receiver to the second computing unit and the correction term and to use the corrected satellite signals for determining a corrected position value of the test unit, wherein the ground arrangement is designed to compare the corrected position value of the test unit with a known actual position value of the test unit.

The design of the test unit corresponds functionally to the design of the aircraft with regard to the GNSS receiver, the data transmission unit and the computing unit, wherein the computing unit of the test unit corresponds to the mission computer of the aircraft. The test unit thus represents a test candidate on which the effects of the transmitted correction term on the signal propagation times determined by the second GNSS receiver can be observed. The test unit applies the correction term to the signal propagation times determined by its GNSS receiver in order to determine a corrected position value of the test unit based on the corrected signal propagation times. Only if this corrected position value of the test unit coincides with the actual position value of the test unit or deviates from it by no more than a predetermined threshold value can it be assumed that the correction term is also suitable for determining the corrected signal propagation times and the actual position value of the aircraft. If the corrected position value of the test unit does not match the actual position value of the test unit or is outside a tolerable range defined by the threshold, this indicates an error of some kind. Such an error may be that the correction term has been calculated incorrectly, that the satellite signal used to determine the position value has not arrived correctly at the GNSS receiver or is disturbed, that the ground station contains some other fault, or that communication by the data transmission unit is disturbed. Some of these errors may be caused by electronic interference or manipulation. The test unit makes it possible to detect the effects of these interference measures or manipulations, or the effects of interference in general.

The comparison of the corrected position value of the test unit with the known actual position value of the test unit can be carried out in the test unit by the second computing unit or in the ground station by its computing unit.

The known position value of the test unit may be stored in the ground station or the test unit. Either the test unit or the ground station then carries out the comparison. If the ground station caries out the comparison, then the position value of the test unit is transferred from the test unit to the ground station before the comparison. For this purpose, a separate data connection (wireless or wired) may be arranged between the ground station and the test unit.

According to a further embodiment, the ground arrangement is designed to generate an alarm signal which indicates an incorrect corrected position value of the test unit in the event of a deviation of the corrected position value of the test unit from the known actual position value of the test unit.

The alarm signal is typically emitted when the difference between the corrected position value of the test unit and the known actual position value of the test unit exceeds a specified threshold.

An incorrect corrected position value of the test unit can have various causes. For example, the correction term as such may have been determined incorrectly. Alternatively, it is conceivable that the satellite signal of the navigation satellite is incorrect or manipulated or has been partially suppressed or superimposed. Furthermore, it is conceivable that the reception quality of an involved GNSS receiver is not sufficient. Therefore, if the test unit detects a signal disturbance (jamming) in the vicinity of the ground station or on the ground in the approach path, or if the test unit detects a deception attempt (spoofing) near the ground station or on the ground in the approach path, a warning will be transmitted to the aircraft. The aircraft may then abort the approach or take other appropriate measures.

However, alarm signals may also be transmitted from the ground station to the aircraft in other circumstances, namely if the test unit or ground station detects an anomaly or obstacle in the vicinity of the ground station or on the ground in the approach path and the approach cannot be made safely.

Conversely, alarm signals can also be transmitted from the aircraft. If the aircraft detects anomalies or objects, such as enemy forces, for example by on-board operating personnel or by sensors, a corresponding warning message can be transmitted to other aircraft or the ground station by a return channel of the data transmission unit. The approach proposed here for correcting the position of the aircraft can then be used to change the approach path of the aircraft or to modify the danger zone.

If the test unit detects incorrect signal propagation times and thus an incorrect corrected position value, then it must be expected that an aircraft that receives the correction term from the ground station will also detect incorrect signal propagation times and an incorrect corrected position value, which may cause the aircraft to miss an intended touchdown point during landing.

The ground arrangement may further be designed that it sends the alarm signal to other aircraft in a given radius in the event of an incorrectly determined corrected position value and informs them of a possible disturbance in the position determination via satellite signals.

According to a further embodiment, the third receiver in the GNSS receiver is designed to determine the signal propagation time between a respective satellite and the GNSS receiver by a pseudo range measurement and optionally a carrier phase measurement on the satellite signals.

As already described in connection with the aircraft, the pseudo range measurement and optionally the carrier phase measurement serve to determine the signal propagation time, wherein the optionally measured and used carrier phase is used to smooth the measurement of the pseudo ranges.

According to a further embodiment, the ground arrangement is designed to transmit the satellite signals received by the GNSS receiver to the remote station.

For example, the raw data received from the GNSS receiver in the ground station, i.e. the satellite signals and the data measured thereon, such as pseudo range and carrier phase, are transmitted to the remote station, for example to an aircraft. Thus, integrity monitoring of the data and measurements used for position determination can be carried out not only in the ground station, but also in the remote station, because the remote station has the data received from the ground station and the measurements made on it.

For the transmission of the correction terms between the ground arrangement and the remote station, protocols from aviation standards are preferably used.

The ground arrangement and the aircraft together form a system, which can be referred to as a ground-based augmentation system (GBAS) or a precision approach and landing system (PALS). The GNSS receivers in the aircraft, the ground station and the test unit may be designed to receive unencrypted and freely accessible or encrypted and non-freely accessible navigation satellite signals and to use them for the determination of the position value. In the aircraft, a function module uses the navigation satellite signals received by a GNSS receiver located in the aircraft, without a separate physical assembly being provided for this. The function module is implemented as software or a function on the aircraft's mission computer. The correction term is received in the aircraft via a data connection, which uses in particular the Link 16 tactical data connection. The Link 16 data connection is an encrypted military-grade data connection and is therefore less susceptible to interference and less susceptible to attack than, for example, an unencrypted wireless radio frequency link.

### BRIEF DESCRIPTION OF THE DRAWINGS

In the following, example embodiments are discussed in more detail on the basis of the attached drawings. The representations are schematic and not true to scale. The same reference characters refer to identical or similar elements. In the figures:

FIG. 1 shows a schematic representation of components of an aircraft according to an example embodiment.

FIG. 2 shows a schematic representation of components of a ground arrangement with a ground station and a test unit according to a further example embodiment.

FIG. 3 shows a schematic representation of a ground station and an aircraft approaching a runway according to a further example embodiment.

### DETAILED DESCRIPTION

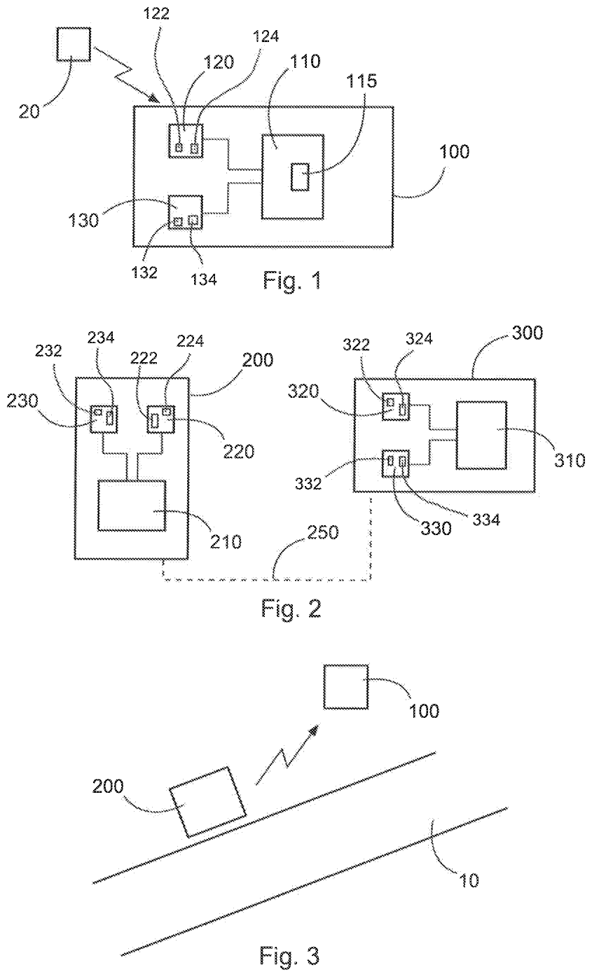

FIG. 1 shows a schematic representation of the components of an aircraft 100 relevant to the present description. The aircraft 100 comprises a mission computer 110, a GNSS receiver 120, and a Link 16 interface 130.

The GNSS receiver 120 comprises a first air interface 122 (for example a GPS antenna) and a first receiver 124. The first air interface 122 is designed to receive navigation signals from several satellites 20 (of which only one is shown). The first receiver 124 is designed to determine the respective signal propagation time based on the received navigation signals. The GNSS receiver 120 transmits the satellite data received from the first receiver 124 and the determined and/or measured signal propagation times (pseudo ranges and possibly carrier phases) to the mission computer 110 so that the mission computer determines the position value and its integrity for the aircraft 100 based on these raw data (pseudo ranges and carrier phases) and the correction term from the ground station.

The Link 16 interface 130 includes a second air interface 132, typically in the form of an antenna, and a second receiver 134 and is designed to receive and/or send data by an encrypted bidirectional communication protocol, such as the Link 16 protocol. For example, military tactical information is transmitted via the Link 16 interface 130. In the present case, the correction term for application to the signal propagation times of the satellite signals is also transmitted.

In FIG. 1 it can be clearly seen that both the GNSS receiver 120 and the data transmission unit 130 are independent modules, each with an air interface 122, 132 and its own receiver 124, 134. A multi-mode receiver can be dispensed with. The GNSS receiver 120 and the data transmission unit 130 pass on the data determined or received by them directly to the mission computer 110. The GNSS receiver 120, the mission computer 110 and the data transmission unit 130 are structurally separated from each other, i.e. such that these three components are arranged separately in the aircraft and are independently replaceable without another component being structurally affected in the event of a replacement or modification of one of the three components. It is possible that a functional adaptation of another component, for example the mission computer, is necessary when replacing one of the components.

The mission computer 110 contains a function module 115, which is designed in particular as a software module and is implemented by the mission computer using a processor and a memory. The function module 115 implements the functions for processing the signal propagation times provided by the GNSS receiver 120 and their correction using the correction term.

The components shown in FIG. 1 are modularly connectable with each other and do not represent a closed assembly that can only be replaced in its entirety. Rather, the function module 115 can be used with changing GNSS receivers 120 or even with different data transmission interfaces. Likewise, the function module 115 can be adjusted or replaced without affecting the other components. In particular, the function module 115 of the mission computer 110 accesses components already existing in the aircraft 100 such as a GNSS receiver 120 and a Link 16 interface 130.

FIG. 2 shows a schematic representation of the components of a ground arrangement, wherein the ground arrangement consists of a ground station 200 and a test unit 300. The ground station 200 and the test unit 300 are in principle similar in design with regard to the components described and used herein as in the aircraft 100.

The ground station 200 comprises a computing unit 210, a GNSS receiver 220, and a data transmission unit 230. The GNSS receiver 220 receives satellite signals and determines the signal propagation time in order to determine the position or a position value of the ground station based on this. The GNSS receiver 220 is similar to the GNSS receiver 120 of the aircraft and has a third air interface 222 and a third receiver 224, which operate similarly to the first air interface 122 and the first receiver 124. As regards the function of the GNSS receiver 220, reference is made to the description of the GNSS receiver 120. The data output by the third receiver 224 are passed to the computing unit 210, where they are processed as a position value. The computing unit 210 determines a correction term based on the position value determined by satellite signals and their signal propagation time and an actual position value of the ground station in order to compensate for an error in the determined signal propagation time, so that the compensated (or corrected) signal propagation times result in the actual position. The computing unit 210 controls the data transmission unit 230 such that the correction term is transmitted by the data transmission unit 230 to a remote station, for example the aircraft 100 from FIG. 1, in order to be used there for the correction of the signal propagation times determined at the remote station. The data transmission unit 230 in this example comprises a third air interface 232 and a third receiver 224. The ground station 200 is thus also of a modular design because the GNSS receiver 220, the data transmission unit 230, and the computing unit 210 operate independently and in particular the GNSS receiver 220 and the data transmission unit 230 are independent modules with an air interface (antenna) and a receiver. The GNSS receiver 220 and the data transmission unit 230 are designed, for example, for receiving encrypted GPS signals or communication signals, as described with reference to the aircraft in FIG. 1.

The ground station 200 may be set up, for example, near a prepared or unprepared runway or generally near a location to be approached by the aircraft 100.

The ground arrangement further comprises a test unit 300 whose functional design corresponds to the functional design of the aircraft 100 with respect to a computing unit 310, a GNSS receiver 320 with a fifth air interface 322 and a fifth receiver 324, and a data transmission unit 330 with a sixth air interface 332 and a sixth receiver 334. The test unit comprises a second computing unit 310, a second GNSS receiver 320, and a second data transmission unit 330. Thus, the test unit 300 is designed to receive the correction term from the ground station 200 and to apply it to the signal propagation times received or determined by the test unit.

In the test unit, the same functions run as in the aircraft 100: the second GNSS receiver 320 receives satellite signals and determines their signal propagation times and, if appropriate, a position value for its own position, the second computing unit 310 applies a correction value, which was received via the second data transmission unit 330, to the signal propagation times in order to determine a corrected position value.

It should be noted, however, that the actual position value of the test unit 300 is known. Thus, the corrected position value can be compared with the actual position value of the test unit 300 in order to determine whether the determination of the corrected position value leads to a meaningful result (i.e. that the corrected position value coincides with the actual position value or deviates from it by less than a predetermined threshold value).

The ground station 200 and the test unit 300 may be connected for this purpose by a separate data connection 250, wherein the separate data connection 250 is in particular a wired data connection. The test unit 300 receives the correction term transmitted by the ground station 200 wirelessly by the second data transmission unit 330. The corrected position value of the test unit 300, on the other hand, is transmitted via the data connection 250 to the ground station 200, where the comparison of the corrected position value of the test unit with the actual position value of the test unit is carried out. Thus, with recourse to the test unit 300, it can be determined whether there is an error in the position determination or in the communication in the system network consisting of the ground station, the test unit and the aircraft.

FIG. 3 shows an example use case of a ground station 200, which is set up near a runway 10 and prepared for data exchange with an aircraft 100 approaching the runway 10. The ground station 200 is fixed to the ground at a known position with a predetermined and known position value and determines a correction term for the signal propagation times of the satellite signals based on the signal propagation times determined by satellite signals and expected target signal propagation times, which correspond to the known position. This correction term is transmitted wirelessly to the aircraft 100 approaching the runway 10 and the aircraft 100 corrects its signal propagation times determined based on satellite signals with the correction term. Thus, the aircraft 100 receives a very accurate corrected position value and an approach to the runway 10 is possible even in poor visibility or with zero visibility.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE CHARACTER LIST

10 runway
20 satellite
100 aircraft
110 mission computer
115 function module
120 GNSS receiver
122 first air interface
124 first receiver
130 data transmission unit
132 second air interface
134 second receiver
200 ground station
210 computing unit
220 GNSS receiver
222 third air interface
224 third receiver
230 data transmission unit
232 fourth air interface
234 fourth receiver
250 data connection
300 test unit
310 computing unit
320 GNSS receiver
322 fifth air interface
324 fifth receiver
330 data transmission unit
332 sixth air interface
334 sixth receiver

1. An aircraft, comprising:
a mission computer;
a Global Navigation Satellite System receiver, a GNSS receiver, with a first air interface and a first receiver;
a data transmission unit with a second air interface and a second receiver, wherein the data transmission unit is configured to receive data via an encrypted, bidirectional communication path;
wherein the first receiver in the GNSS receiver is configured to receive satellite signals from satellites, which enable determination of a signal propagation time between a respective satellite and the GNSS receiver, wherein the satellite signals can be used for determining a position value of the aircraft;
wherein the GNSS receiver is configured to transmit the determined signal propagation time to the respective satellite to the mission computer;
wherein the data transmission unit is configured to receive a correction term for applying to the satellite signals received from the GNSS receiver from a remote station and to transmit them to the mission computer;
wherein the mission computer implements a function module which is configured to determine corrected satellite signals based on the satellite signals transmitted by the GNSS receiver to the mission computer and the correction term and to use the corrected satellite signals for determining a position value of the aircraft;
wherein the GNSS receiver is configured to be used for navigation in the aircraft;
wherein the data transmission unit is configured to transmit data between the aircraft and the remote station; and
wherein the function module in the mission computer is structurally separated from the GNSS receiver and the data transmission unit.

2. The aircraft of claim 1, wherein the function module is implemented as a software module and is configured to be executed on the mission computer.

3. The aircraft of claim 1, wherein the GNSS receiver is configured to receive and process satellite signals from a satellite from a satellite navigation system selected from the group consisting of GPS, Galileo, Glonass, and Beidou.

4. The aircraft of claim 1, wherein the first receiver in the GNSS receiver is configured to determine the signal propagation time between a respective satellite and the GNSS receiver by a pseudo range measurement and optionally a carrier phase measurement on the satellite signals.

5. The aircraft of claim 1, wherein the first receiver is configured to receive encrypted satellite signals for determining a position of the aircraft and to decrypt the encrypted satellite signals.

6. The aircraft of claim 1, wherein the function module of the mission computer is configured as a remote station of a ground-based approach and landing system.

7. The aircraft of claim 1, wherein the data transmission unit is configured to receive flight path-related data for the aircraft.

8. An aircraft of claim 1,
wherein the data transmission unit is configured to transmit data to the remote station and/or to other aircraft;
wherein the data transmitted to the remote station are one or more elements from:
an approach path chosen by the aircraft;
corrected signal propagation times determined by the correction term.

9. The aircraft of claim 1, wherein the aircraft is a manned or unmanned military aircraft.

10. A ground arrangement of a ground-based approach and landing system, wherein the ground arrangement comprises a ground station and the ground station comprises:
a computing unit;
a global navigation satellite system receiver, a GNSS receiver, with a third air interface and a third receiver;
a data transmission unit having a fourth air interface and a fourth receiver, wherein the data transmission unit is configured to receive data via an encrypted, bidirectional communication path;
wherein the third receiver in the GNSS receiver is configured to receive satellite signals from satellites which enable determination of a signal propagation time between a respective satellite and the GNSS receiver, wherein the satellite signals can be used for determining a position value of the ground station;
wherein the GNSS receiver is configured to transmit the satellite signals to the computing unit;
wherein the computing unit is configured to determine a correction term for the satellite signals received from the GNSS receiver based on the satellite signals received from the GNSS receiver and a known actual position value of the ground station so that the correction term, after application to the satellite signals transmitted by the GNSS receiver to the computing unit, gives corrected satellite signals corresponding to the actual position value of the ground station;
wherein the data transmission unit is configured to transmit the correction term to a remote station; and
wherein the computing unit is structurally separated from the GNSS receiver and the data transmission unit.

11. The ground arrangement of claim 10, comprising:
a test unit with a second computing unit, a second GNSS receiver, and a second data transmission unit, which is configured to receive data via an encrypted, bidirectional communication path;
wherein the test unit is spatially separated from the ground station;
wherein the second GNSS receiver is configured to receive satellite signals from satellites, which enable determination of a signal propagation time between a respective satellite and the second GNSS receiver, wherein the satellite signals can be used for determining a position value of the test unit;
wherein the second GNSS receiver is configured to transmit the satellite signals to the second computing unit;
wherein the ground station is configured to transmit the correction term by the data transmission unit to the second data transmission unit;
wherein the second computing unit is configured to determine corrected satellite signals based on the satellite signals transmitted by the second GNSS receiver to the second computing unit and the correction term and to use the corrected satellite signals for determining a corrected position value of the test unit;
wherein the ground arrangement is configured to compare the corrected position value of the test unit with a known actual position value of the test unit.

12. The ground arrangement of claim 11, wherein the ground arrangement is configured to generate an alarm signal in an event of a deviation of the corrected position value of the test unit from the known actual position value of the test unit, which indicates an incorrect corrected position value of the test unit.

13. The ground arrangement of claim 10, wherein the third receiver in the GNSS receiver is configured to determine the signal propagation time between a respective satellite and the GNSS receiver by a pseudo range measurement and optionally a carrier phase measurement on the satellite signals.

14. The ground arrangement of claim 10, wherein the ground arrangement is configured to transmit the satellite signals received by the GNSS receiver to the remote station.
